(19) United States
(12) Patent Application Publication
(10) Pub. No.: US 2013/0269794 A1
(43) Pub. Date: Oct. 17, 2013

(54) SHOWER AND TUB FIXTURE INSERT

(71) Applicant: Peter M. FIELD, Belleview, FL (US)

(72) Inventor: Peter M. FIELD, Belleview, FL (US)

(21) Appl. No.: 13/531,251

(22) Filed: Jun. 22, 2012

Related U.S. Application Data
(60) Provisional application No. 61/623,352, filed on Apr. 12, 2012.

(51) Int. Cl. F16L 5/00

(52) U.S. Cl. 137/359

(57) ABSTRACT

A shower or combination shower/tub fixture insert for installation in shower and/or combination shower/tub surround openings, the insert comprising: 1) a concealment panel having a front side and a back side, and including a first aperture therethrough, 2) a shower valve mounted to the back side of the panel and partially extending through the first aperture, the shower valve including a handle, 3) connection means mounted to the shower valve for connection to the available hot water, cold water, and shower head pipes; and 4) an escutcheon plate sized to cover the first aperture of said concealment panel when mounted to said shower valve. The apparatus permits rapid installation of new or replacement tub and shower fixtures through an opening in the shower or combination shower/tub surround without the need for soldering and provides easy access to shower plumbing for future repairs or replacement.

### RELATED APPLICATION

This application claims the benefit of U.S. Provisional Application No. 61/623,352 filed Apr. 12, 2012 and entitled, In-Wall Bathroom Fixture Assembly.

### FIELD OF THE INVENTION

The present invention relates generally to bathroom plumbing fixtures and more particularly to shower and shower/tub fixture insert for shower and/or combination shower/tub enclosures.

### BACKGROUND OF THE INVENTION

Replacement of a shower valve can be a challenging and time consuming task, even for a skilled plumber. Shower valves are important because they control the flow of water in the right direction, at the desired pressure and at the desired temperature. In order to eliminate the risk of scalding it is common for older fixtures to be replaced with more modern ones, such as “balanced” pressure valves that maintain water temperature even when there is a drop in cold water pressure. However, many do-it-yourselfers lack the requisite skills to perform this multi-step task.

The shower valve is located inside the wall behind the shower handle and escutcheon plate and must be accessible from the front or back to replace it. Most often, this involves opening the wall behind the valve to gain access rather than cutting through the tile, fiberglass or other shower surround materials which will be much more difficult or impossible to repair than drywall. Unfortunately, repair of the surround is not always an option because the tile used is no longer available and the cut out portion of the surround is too large to cover with commercially available trim plates. Moreover, often times the wall behind the valve is not accessible leaving no choice but to remove a portion of the surround. It would therefore be desirable to have a means for concealing the frontal opening in the surround (hereinafter, “surround opening”) after the repair or replacement of the valve is accomplished.

The opening created in the surround must be large enough to gain access not only to the valve, but to neighboring pipes connected thereto. The shower valve will have three or four pipes connected to it. If this is a shower only, it will typically have three copper pipes attached to it (one on each side and one at the top); if it is a tub/shower combination, four pipes will be connected to it (the additional pipe at the bottom flows water to the tub spout). The existing valve must be disconnected from these pipes by either sweating the connections or cutting through the pipes with a pipe cutter. Because sweating of the connections involves the use of a gas torch producing a flame that can reach a temperature of 1200 degrees Fahrenheit creating a serious risk of fire, especially to the inexperienced do-it-yourselfer, cutting of the pipes is the preferred method for the layperson.

Another challenging aspect of valve replacement or even new valve installations is that the copper pipes must be accurately cut or installed, respectively, so as to create a void where the new valve will go. Short lengths of copper pipe must be soldered to the adapters of the new valve so when the new valve is held into the void, the ends of the cut pipes fit together very closely for application of a repair coupling to connect the ends. This can be exceptionally challenging for the inexperienced and once again, a torch must be used to solder the coupling in place. Moreover, the shower cartridge in the valve must be removed to avoid the risk of damaging the cartridge from the heat of the torch. It would be desirable to have a means for installing a new valve assembly without the need for a torch, without the need for precise alignment of the valve pipes with the corresponding water supply pipes and shower head piping and without the need for removal of the valve cartridge.

The subject invention satisfies the above described needs in the art and obviates the risks associated with conventional shower valve installation or replacement.

### SUMMARY OF THE INVENTION

The subject invention more specifically relates to a shower or combination shower/tub fixture insert for installation in shower and/or combination shower/tub surround openings. The subject apparatus is comprised of three primary components, namely: 1) a concealment panel having a front side and a back side, and including at least one aperture therethrough, 2) a shower valve mounted to the back side of the panel and including a hot water inlet, a cold water inlet, a shower head outlet, a tub spout outlet, and a valve stem projecting through the aperture of the panel, and 3) connection means for connecting the hot and cold water inlets and the shower head outlet to their respective hot and cold water pipes and shower head pipe. In another embodiment of the invention the tub faucet outlet is fixedly attached to tub spout piping an end of which projects through a second panel aperture for mounting of a tub spout thereon. In a preferred embodiment, the apparatus further includes shower head and tub spout fixtures and mounting means therefore. The apparatus permits rapid installation of new or replacement tub and shower fixtures through an opening in the shower or combination shower/tub surround without the need for soldering and provides easy access to shower plumbing for future repairs or replacement.

There has thus been outlined, rather broadly, the more important components of the subject invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Accordingly, it is a primary object of the present invention to provide a shower or combination shower/tub fixture insert for shower and shower/tub enclosures that is capable of rapid installation without the need for soldering or precise alignment of valve outlets and inlets with plumbing lines.

It is another primary object of the subject invention to provide a shower or combination shower/tub fixture insert mbly for shower and shower/tub enclosures that eliminates multiple installation steps required in conventional fixture installation and replacement.

It is another object of the subject invention to provide a shower or combination shower/tub fixture insert for shower and shower/tub enclosures wherein at least the exterior (i.e., shower facing) components are fabricated from materials that are durable, corrosion-resistant, and non-absorbent.

Another object of the subject invention is to provide a shower or combination shower/tub fixture insert for shower and shower/tub enclosures wherein exterior (i.e., shower facing) components are fabricated from materials that are sufficient in weight and thickness to withstand repeated exposure to water and cleaning agents.

Another object of the subject invention is to provide a shower or combination shower/tub fixture insert for shower and shower/tub enclosures wherein exterior (i.e., shower facing) components are fabricated from materials that may be finished to possess a smooth, easily cleanable surface.

Still another object of the subject invention is to provide a shower or combination shower/tub fixture insert for shower and shower/tub enclosures wherein exterior (i.e., shower facing) components are fabricated from materials that are resistant to pitting, chipping, crazing, scratching, scoring, distortion and decomposition.

It is also an object of the subject invention is to provide a shower or combination shower/tub fixture insert for shower and shower/tub enclosures wherein exterior (i.e., shower facing) components are constructed to be free of breaks, open seams, cracks, chips, inclusions, pits, and similar imperfections.

Still another object of the subject invention is to provide a shower or combination shower/tub fixture insert for shower and shower/tub enclosures wherein exterior (i.e., shower facing) components are substantially free of sharp internal angles, corners, and crevices which could retain moisture, bacteria, molds and other deleterious substances.

Another object of the subject invention is to provide a shower or combination shower/tub fixture insert for shower and shower/tub enclosures that is relatively simple in design and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevation view of a shower or combination shower/tub fixture insert according to the subject invention;

FIG. 2 is a rear elevation view of the apparatus of FIG. 1;

FIG. 3 is a front elevation view of a first embodiment of the concealment panel component of the subject apparatus; and

FIG. 4 is rear elevation view of the concealment panel of FIG. 3.

### DETAILED DESCRIPTION OF THE PREFERRED EMBODIMENT

At the outset, it should be clearly understood that like reference numerals are intended to identify the same structural elements, portions or surfaces consistently throughout the several drawings figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal” and “vertical” simply refer to the orientation of an object relative to level ground, and the term “front” refers to the control side of the apparatus (i.e., the side with the valve handle or to which the valve handle is mounted).

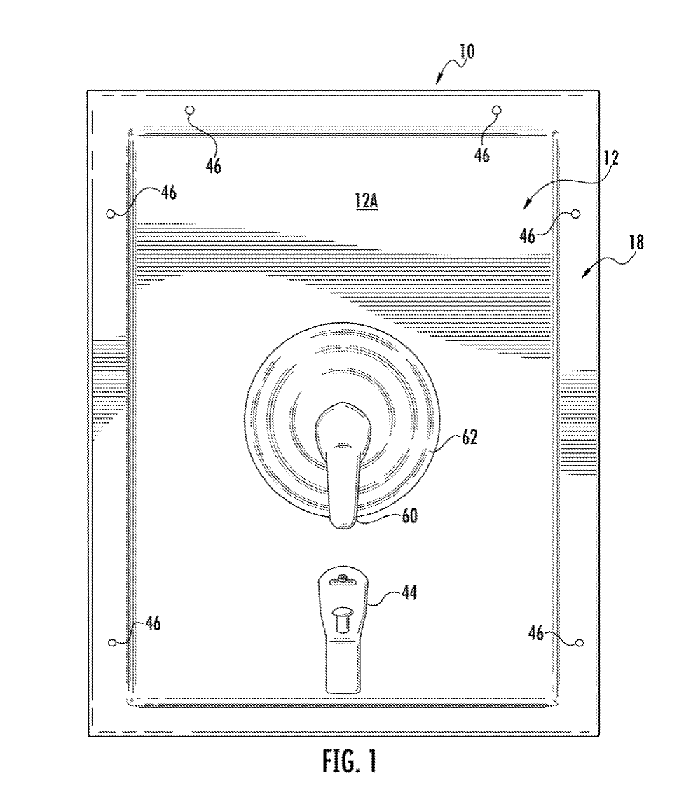

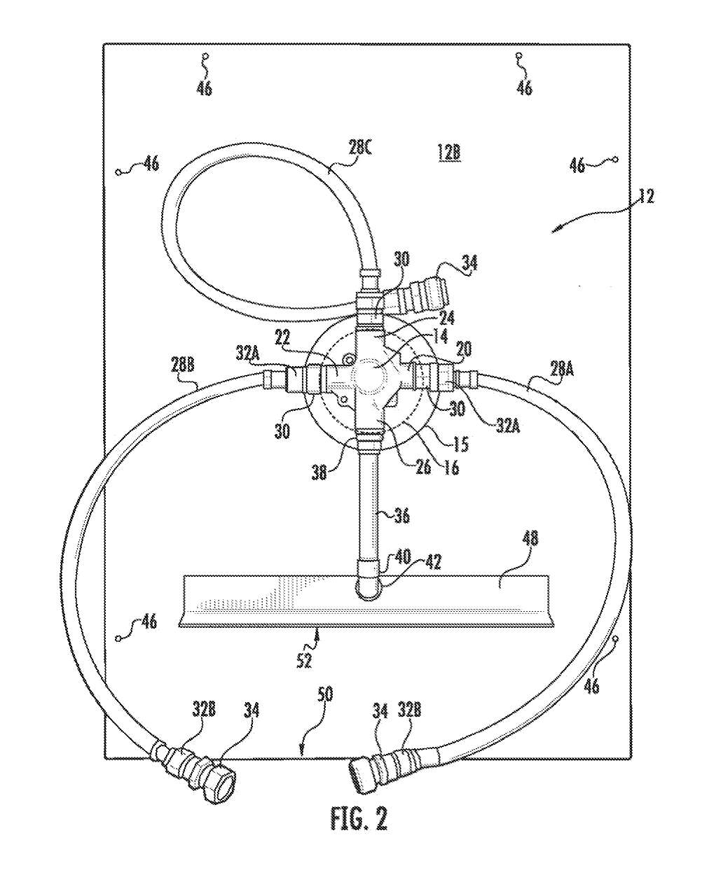

With reference now being made to FIGS. 1-2, there is illustrated front and rear elevation views of a shower or combination shower/tub fixture insert of the subject invention (hereinafter “fixture insert”) designated generally by reference numeral 10. Fixture insert 10 is comprised of three primary components, namely: 1) a concealment panel 12, 2) a shower valve 14 mounted to panel 12, and 3) connection means mounted to shower valve 14 for connecting the apparatus to available shower plumbing lines.

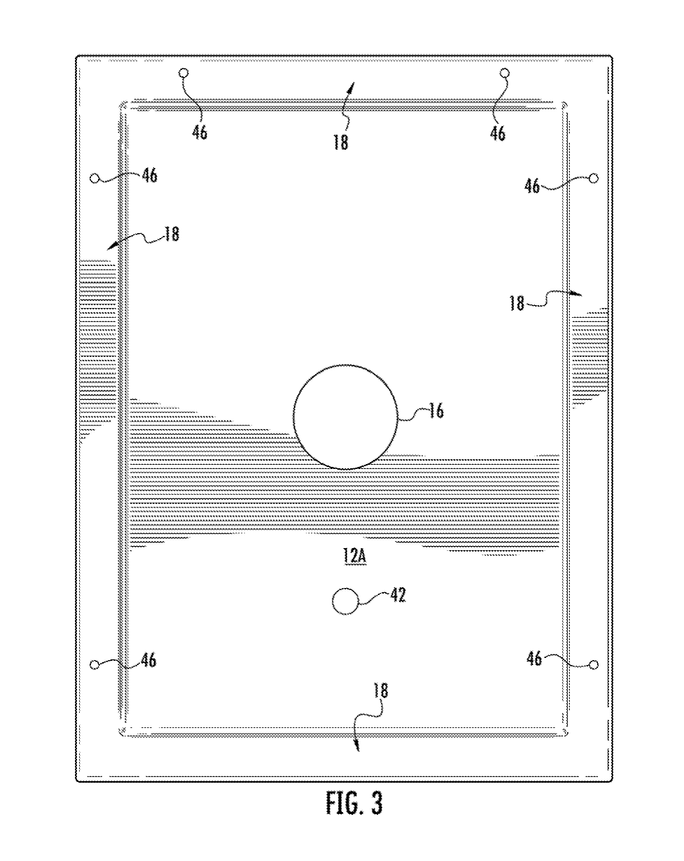

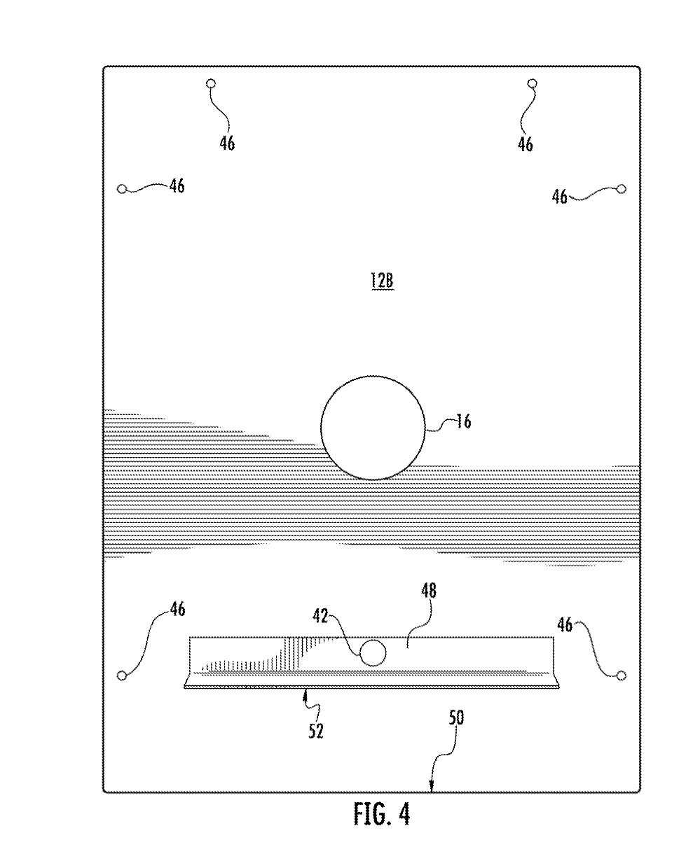

With additional reference to FIGS. 3 and 4, concealment panel 12 includes a front side 12A, a back side 12B, and first aperture 16 disposed therethrough. Panel 12 is preferably, but not essentially, rectangular in shape and sized to span neighboring framing members (typically 16″ on center) between which the surround opening is cut. First aperture 16 is sized to permit valve 14 to be seen therethrough while being diametrically small enough to be covered by conventional escutcheon plates (trim plates). First aperture 16 is centrally located on panel 12. Panel 12 optionally includes perimeter framing 18 which extends a distance above the surface of front side 12A. A distance sufficient to accommodate the thickness of conventional tile and mortar is preferred such that the area of panel 12 within the bounds of framing 18 may be decorated with tile to match or compliment the appearance of the shower enclosure to which the apparatus is mounted. Panel 12 is constructed of material that is: 1) lightweight, thus lending itself to ease of transport, 2) corrosion and mildew resistant, 3) durable enough to withstand deformation when mounted to a wall, and 4) non-absorbent. By way of example only, panel 12 may be constructed of high density polyethylene, a clean, white, high-impact plastic material that is almost unbreakable. As an alternative, the subject apparatus may be fabricated from polypropylene to exhibit very high corrosion-resistance to acidic, alkaline and saline solutions. The polypropylene construction has high tensile strength and tremendous impact strength and very importantly has virtually no water absorption. Another viable alternative is to fabricate the apparatus from fiberglass which will provide a smooth surface with rounded corners for easy cleaning. Sturdy fiberglass won't dent, chip, bend, peel, crack or warp. Fiberglass is suitable for coloring of the panel for decorative purposes and is impervious to detergents and resistant to industrial cleaners. Yet another viable alternative is to cover panel 12 with materials commonly used on bathroom fixtures such as chrome, nickel and bronze all of which may be finished to possess a smooth, easily cleanable surface that is resistant to pitting, chipping, crazing, scratching, scoring, distortion and decomposition.

Shower valve 14 (hereinafter sometimes referred to more simply as “valve 14”) is mounted to the back side 12B of panel 12 and includes a hot water inlet stub 20, a cold water inlet stub 22, a shower head outlet stub 24, a tub spout outlet stub 26, and a threaded valve stem (not shown) projecting through first aperture 16 of panel 12. As used herein, the term “shower valve” means any kind of control valve for shower or combination tub and shower enclosure fixtures including, but not limited to, HiFlow valves, single-control pressure valves, thermostat shower valves, valves with separate temperature and volume controls, single control valves for presetting of water temperature, and the like. Shower valve 14 may be mounted to back panel 12B, substantially centered behind first aperture 16, in a variety of ways and using a variety of mounting means adapted for this purpose (hereinafter “valve mounting means”). In a preferred embodiment, valve mounting means is comprised of a plaster ground spacer 15 having a diameter greater than that of first aperture 16, and a pair of mounting screws (not shown). The screws are threaded through escutcheon plate 62, through plaster ground spacer 15, and into valve 14. As the screws are tightened, escutcheon plate 62 and plaster ground spacer 15 are drawn closer together and against front side 12A and back side 126, respectively, of concealment panel 12, thus securing valve 14 in a stationary position.

First and second flexible water supply connectors 28A,28B are connected to cold and hot water inlets 20,22 of valve 14, respectively, and third flexible water supply connector 28C is connected to shower head outlet stub 24, all via adapters 30. Adapters 30 may be of a variety of types and may be a single fitting or combination of fittings. In a preferred embodiment, each adapter 30 is of a Brass Male Hose to Male Pipe Adapter type which includes a non-threaded male end or stub diametrically sized for frictional engagement within the female opening of valve stubs 20,22,24, and a non-threaded male end for frictional engagement within the female opening of a first end of water supply connecters 28A-C. Those skilled in the art will recognize the proper methods of attachment via sweating and use of Teflon tape, etc.

Water supply connectors 28A-C are of the flexible lead-free variety and preferably but not essentially of the reinforced PVC type comprising PVC tubing jacketed with braided nylon and an outer protective layer of PVC which offer protection from vibration and bursting under extreme pressure surges. Various end connections are available with the embodiment illustrated herein having two threaded female ends. Alternatively, water supply connectors 28A-C may be constructed of PVC tubing jacketed with braided stainless steel, or any other suitable flexible water supply connector known in the art. The use of flexible water supply connectors 28A-C requires no tube cutting, bending, or soldering during installation of the subject apparatus into a shower or shower/tub enclosure.

As stated above, the water supply connectors 28A-C utilized in the instant embodiment of the subject invention include two female ends. First end 32A is attached to an adapter 30 while the opposite, second end 32B of each water supply connector 28A-C has mounted thereto a “quick-connect” (preferred) or compression fitting 34. The compression fitting is composed of an outer compression nut and an inner compression ring; or ferrule that is usually made of brass or copper. Ferrules vary in shape and material but are most commonly in the shape of a ring with beveled edges and they are most commonly made out of brass or according to the pipe material. To work properly, the ferrule must be oriented correctly; typically the ferrule is fitted such that the longest sloping face of the ferrule faces away from the nut. The use of compression fittings to accomplish connections to hot and cold water supply lines and to the shower head supply line is ideal because of the confined space within which these lines are located and because the copper piping would is difficult to solder without creating a fire hazard. The installer of the subject apparatus need only attach the compression fittings to the aforesaid piping to provide a leak tight seal. When the nut is tightened, the ferrule is compressed between the nut and the receiving fitting; the ends of the ferrule are clamped around the pipe, and the middle of the ferrule bows away from the pipe, making the ferrule effectively thicker. The result is that the ferrule seals the space between the pipe, nut, and receiving fitting, thereby forming a tight joint. Those familiar with quick-connect fittings (shown) will of course recognize the ease with which they are mated to a pipe in a “slip-on” frictional engagement fashion with nut to tighten.

In shower only installations, as opposed to shower/tub installations, tub faucet outlet stub 26 is closed off with a plug (not shown). Where both shower and tub installations are involved, tub faucet outlet stub 26 is connected to a length of tub spout pipe 36 via coupling fixture 38 by means of soldering when copper piping is employed. Those skilled in the art will recognize that alternative piping may be used such as, for example, PEX piping mounted to valve 14 with a PEX adapter. Pipe 36 terminates at its opposite end in elbow joint 40. The free end of elbow joint 40, or a short length of pipe fixedly mounted thereto, is disposed through a second aperture 42 in panel 12 and threaded to receive tub spout 44 in a manner well known to those skilled in the art. Together, tub spout pipe 36, elbow joint 40, and the short length of pipe (when employed) fixedly mounted to elbow joint 40 are referred to as a “tub spout piping assembly”. Second aperture 42 is located a distance below first aperture 16, approximately 5″ to 8″.

As should now be appreciated, the subject apparatus 10 may include a myriad of different decorative shower heads, pre-mounted control handles 60 and escutcheon plates 62, and pre-mounted tub spouts 44, to provide a ready-to-install fixture assembly capable of rapid in-wall installation. To that end, framing 18 of panel 12 may include a plurality of predrilled mounting holes 46 about its perimeter for the receipt of mounting screws (not shown). To further facilitate ease of installation, back side 12B of panel 12 includes a horizontal flange 48 extending across a portion thereof between first aperture 16 (or second aperture 42 when present) and the bottom edge 50 of panel 12. Flange 48 may, for instance, be comprised of a bracket, L-shaped in cross-section, having one side of the L mounted to back side 12B of panel 12 and the other side of the L extending perpendicularly therefrom forming a horizontal shelf 52 which serves as a support for bearing a substantial percentage of the weight of the apparatus as a whole when mounted to the shower or shower/tub enclosure, and during the mounting process itself. As may be appreciated, shelf 52 of flange 48 will rest on the bottom edge of the surround opening and can serve as a pivot point for the apparatus during the mounting process to facilitate connection of hoses to existing pipes. Panel 12 is then secured to the wall via the aforesaid mounting hardware and caulk applied about its perimeter to form a waterproof seal between plate 12 and the wall surface.

Based on the above description of the apparatus and the method of installation it should be readily understood and appreciated that the apparatus permits rapid installation of new or replacement tub and shower fixtures without the need for soldering, and provides easy access to shower plumbing for future repairs or replacement.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A shower or combination shower/tub fixture insert for connection to available hot water, cold water, and shower head pipes accessible through an opening in a shower and/or combination shower/tub surround, the insert comprising: 1) a concealment panel having a front side, a back side, and a first aperture therethrough, 2) a shower valve mounted to said back side of said concealment panel and partially extending through said first aperture, said shower valve including a handle, 3) connection means mounted to said shower valve for connection to the available hot water, cold water, and shower head pipes; and 4) an escutcheon plate sized to cover said first aperture of said concealment panel when mounted to said shower valve, whereby said concealment panel may be mounted to the shower and/or a combination shower/tub surround to conceal the opening therethrough.

2. The shower or combination shower/tub fixture insert of claim 1, further including a flange horizontally mounted to said back side of said concealment panel below said to bear the weight of the insert when rested upon a horizontal framing member and/or bottom edge of the surround opening.

3. The shower or combination shower/tub fixture insert of claim 1, wherein said connection means is comprised of a first flexible water supply connector for connection to the available hot water pipe, and a second flexible water supply connector for connection to the cold water pipe.

4. The shower or combination shower/tub fixture insert of claim 2, wherein said connection means is comprised of a first flexible water supply connector for connection to the available hot water pipe, and a second flexible water supply connector for connection to the cold water pipe.

5. The shower or combination shower/tub fixture insert of claim 1, further including a second aperture below said first aperture sized for the receipt of tub spout piping therethrough.

6. The shower or combination shower/tub fixture insert of claim 2, further including a second aperture below said first aperture sized for the receipt of tub spout piping therethrough.

7. The shower or combination shower/tub fixture insert of claim 3, further including a second aperture below said first aperture sized for the receipt of tub spout piping therethrough.

8. The shower or combination shower/tub fixture insert of claim 4, further including a second aperture below said first aperture sized for the receipt of tub spout piping therethrough.

9. The shower or combination shower/tub fixture insert of claim 5, further including a tub spout piping assembly connected to said shower valve, said tub spout piping assembly having a portion thereof disposed through said second aperture for the receipt of a tub spout thereon.

10. The shower or combination shower/tub fixture insert of claim 6, further including a tub spout piping assembly connected to said shower valve, said tub spout piping assembly having a portion thereof disposed through said second aperture for the receipt of a tub spout thereon.

11. The shower or combination shower/tub fixture insert of claim 7, further including a tub spout piping assembly connected to said shower valve, said tub spout piping assembly having a portion thereof disposed through said second aperture for the receipt of a tub spout thereon.

12. The shower or combination shower/tub fixture insert of claim 8, further including a tub spout piping assembly connected to said shower valve, said tub spout piping assembly having a portion thereof disposed through said second aperture for the receipt of a tub spout thereon.

13. The shower or combination shower/tub fixture insert of claim 9, further including a tub spout operably connected to said tub spout piping assembly.

14. The shower or combination shower/tub fixture insert of claim 10, further including a tub spout operably connected to said tub spout piping assembly.

15. The shower or combination shower/tub fixture insert of claim 11, further including a tub spout operably connected to said tub spout piping assembly.

16. The shower or combination shower/tub fixture insert of claim 12, further including a tub spout operably connected to said tub spout piping assembly.

17. The shower or combination shower/tub fixture insert of claim 1, further including perimeter framing extending a distance above the surface of said front side of said concealment panel.

18. The shower or combination shower/tub fixture insert of claim 2, further including perimeter framing extending a distance above the surface of said front side of said concealment panel.

19. The shower or combination shower/tub fixture insert of claim 3, further including perimeter framing extending a distance above the surface of said front side of said concealment panel.

20. The shower or combination shower/tub fixture insert of claim 4, further including perimeter framing extending a distance above the surface of said front side of said concealment panel.
